(19) United States
(12) Patent Application Publication
(10) Pub. No.: US 2025/0042045 A1
(43) Pub. Date: Feb. 6, 2025

(54) ROBOT HAND, ROBOT, AND ROBOT CONTROL SYSTEM

(71) Applicant: KYOCERA Corporation, Kyoto-shi, Kyoto (JP)

(72) Inventors: Tetsuya TOICHI, Osaka-shi, Osaka (JP); Masahiro UCHITAKE, Kobe-shi, Hyogo (JP)

(21) Appl. No.: 18/722,525

(22) PCT Filed: Dec. 23, 2022
(86) PCT No.: PCT/JP2022/047748

§ 371 Date: Jun. 20, 2024

(30) Foreign Application Priority Data
Dec. 23, 2021 (JP) 2021-209857

(51) Int. Cl. B25J 15/10; B25J 13/08

(52) U.S. Cl. CPC B25J 15/10; B25J 13/081

(57) ABSTRACT

The robot hand includes a plurality of finger parts which grips a grip target object. The plurality of finger parts includes a plurality of finger bodies and a plurality of elastic members provided to the plurality of finger bodies. The plurality of elastic members includes a portion having a Young's modulus in a first direction lower than a Young's modulus in a second direction. The first direction is a direction in which grip force acts on the grip target object. The second direction intersects the first direction.

### CROSS-REFERENCE TO RELATED APPLICATIONS

This application claims priority to Japanese Patent Application No. 2021-209857 (filed on Dec. 23, 2021), the entire contents of which are incorporated herein by reference.

### TECHNICAL FIELD

The present disclosure relates to a robot hand.

### BACKGROUND OF INVENTION

A known grip control method can lift, by using a robot hand or a manipulator, an object having an unknown weight and friction coefficient, without misalignment of a grip position (for example, see Patent Literature 1).

### CITATION LIST

### Patent Literature

Patent Literature 1: Japanese Unexamined Patent Application Publication No. 2000-254884

### SUMMARY

In one embodiment of the present disclosure, a robot hand includes a plurality of finger parts. The plurality of finger parts grips a grip target object. The plurality of finger parts includes a plurality of finger bodies and a plurality of elastic members. The plurality of elastic members is provided to the plurality of finger bodies. The plurality of elastic members includes a portion having a Young's modulus in a first direction lower than a Young's modulus in a second direction. The first direction is a direction in which grip force acts on the grip target object. The second direction intersects the first direction.

In one embodiment of the present disclosure, a robot includes the robot hand and an arm. The robot hand is connected to the arm.

In one embodiment of the present disclosure, a robot control system includes the robot and a controller. The controller controls the robot.

### BRIEF DESCRIPTION OF THE DRAWINGS

FIG. 1 is a sectional view illustrating a configuration example of a robot hand according to one embodiment.

FIG. 2 is an enlarged view of a part surrounded by a one-dot chain line in FIG. 1 and illustrates one example of an elastic member gripping a grip target object.

FIG. 3 is a sectional view illustrating a configuration example in which a support regulates motion of the elastic member.

FIG. 4 is a sectional view illustrating an elastic member of a robot hand according to a comparative example.

FIG. 5 is a schematic view illustrating a configuration example of a robot hand including a grip finger and a regulation finger.

FIG. 6 is a plan view illustrating a configuration example of the robot hand including the grip finger and the regulation finger.

FIG. 7 is a sectional view illustrating another configuration example of an elastic member.

FIG. 8 is a sectional view taken along a line A-A in FIG. 7.

FIG. 9 is a sectional view illustrating a configuration example when the elastic member in FIG. 7 grips a grip target object.

FIG. 10 is a sectional view illustrating a configuration example of an elastic member in which a first elastic member and a second elastic member are not layered on one another in a first direction, but the first elastic member is positioned at an inner side.

FIG. 11 is a sectional view illustrating a configuration example of an elastic member in which the first elastic member and the second elastic member are not layered on one another in the first direction, but the first elastic member is positioned at an outer side.

FIG. 12 is a sectional view illustrating another configuration example of a robot hand.

FIG. 13 is a sectional view illustrating a configuration example of a robot hand including a sensor.

FIG. 14 is a schematic view illustrating a configuration example of a robot hand including a finger part including an elastic member, and a finger part not including an elastic member.

FIG. 15 is a schematic view illustrating a configuration example of a robot control system according to one embodiment.

### DESCRIPTION OF EMBODIMENTS

### (Configuration Example of Robot Hand 10)

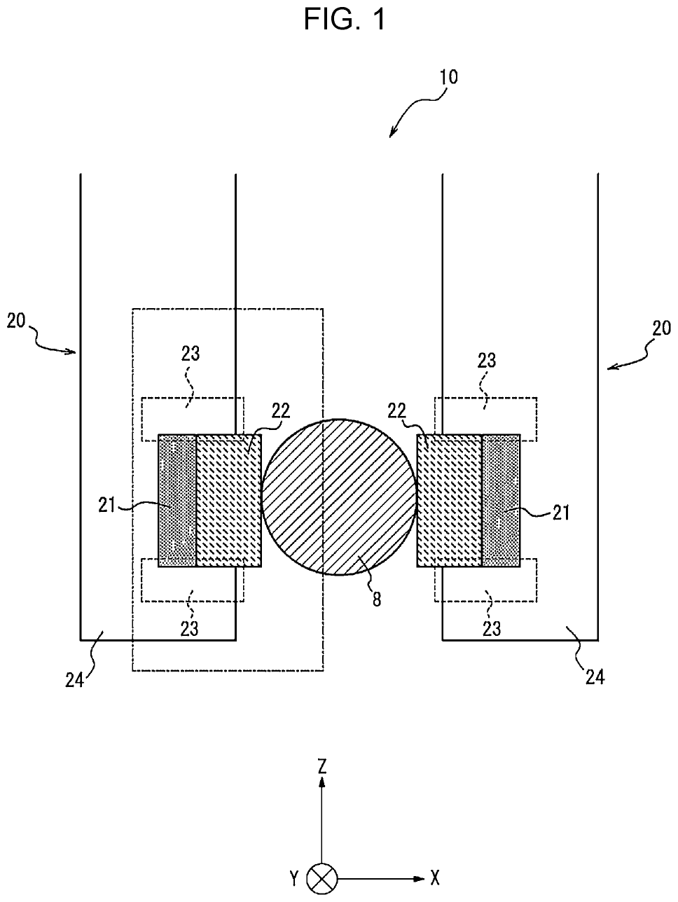

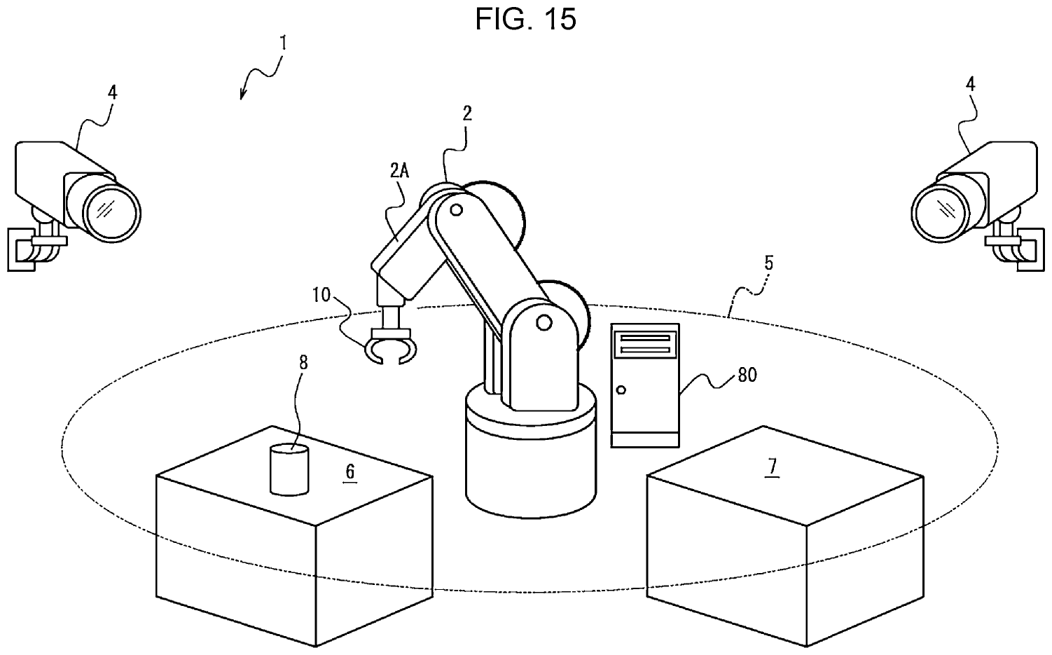

In one embodiment of the present disclosure, a robot 2 (see FIG. 15) includes a robot hand 10 installed thereto. The robot hand 10 includes a finger for gripping a grip target object 8 (see FIG. 1 and the like).

### <Regulation Implementation by Elastic Member Characteristics>

The robot hand 10 may include two finger parts 20 as illustrated in FIG. 1, for example. The two finger parts 20 grip the grip target object 8. At least one finger part 20 includes a first elastic member 21, a second elastic member 22, and a finger body 24. A Young's modulus of the first elastic member 21 may be lower than a Young's modulus of the second elastic member 22. The first elastic member 21 and the second elastic member 22 are also collectively referred to as an elastic member. When the finger part 20 grips the grip target object 8, a grip force acts in a direction normal to a surface where the finger part 20 contacts the grip target object 8. The direction in which the grip force acts is also referred to as a first direction. In FIG. 1, the first direction corresponds to an X-axis direction.

The finger body 24 includes a support 23 supporting the elastic member. The support 23 supports the elastic member in such a manner as to regulate motion of the elastic member in a direction intersecting the first direction. The direction intersecting the first direction is also referred to as a second direction. In the case in which the first direction corresponds to the X-axis direction, the second direction corresponds to a direction including a Y-axis direction component or a Z-axis direction component. The support 23 regulates motion of the elastic member in the second direction, the elastic member contacting the grip target object 8, when the finger part 20 grips the grip target object 8.

In FIG. 1, the support 23 is an inner wall of a recess provided to the finger body 24. In other words, the elastic member is accommodated in the recess provided to the finger body 24, and thereby the inner wall of the recess of the finger body 24 functions as the support 23. To put it another way, each elastic member of the plurality of elastic members is provided to a respective recess of the plurality of recesses of the corresponding finger bodies 24.

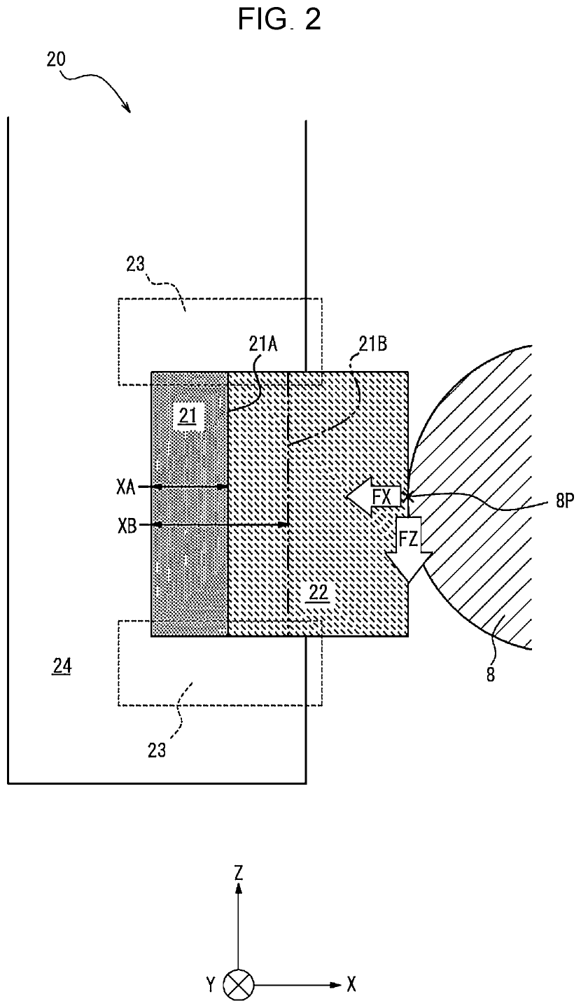

FIG. 2 illustrates one example of the elastic member gripping the grip target object 8. FIG. 2 corresponds to an enlarged view of a part surrounded by a broken line in FIG. 1. A position at which the elastic member and the grip target object 8 contact one another when the finger part 20 grips the grip target object 8 is referred to as a contact point 8P. As reaction force for force which acts on the grip target object 8, grip force FX in the X-axis direction acts on the elastic member from the contact point 8P. The grip force FX compresses the elastic member. In this example, a Young's modulus of the first elastic member 21 in the X-axis direction is lower than a Young's modulus of the second elastic member 22 in the X-axis direction, for example. In this case, compression of the first elastic member 21 in the X-axis direction is larger than that of the second elastic member 22. Deformation of the second elastic member 22 in the X-axis direction is assumed to be negligibly small.

A solid line 21A indicates an inner-side surface (a surface facing to the grip target object 8) of the first elastic member 21 while the grip force FX acts on the first elastic member 21. On the other hand, a two-dot chain line 21B indicates the inner-side surface of the first elastic member 21 while the grip force FX does not act on the first elastic member 21. XA indicates a thickness of the first elastic member 21 in the X-axis direction while the grip force FX acts on the first elastic member 21. XB indicates a thickness of the first elastic member 21 in the X-axis direction while the grip force FX does not act on the first elastic member 21. XB-XA indicates a compression amount of the first elastic member 21 caused by the grip force FX.

A low Young's modulus of the first elastic member 21 in the X-axis direction makes a Young's modulus of the elastic member in the X-axis direction low as a whole. The low Young's modulus of the elastic member in the X-axis direction makes the magnitude of the grip force applied to the grip target object 8 small even when the finger part 20 makes a large movement so that the finger part 20 grips the grip target object 8 in the X-axis direction. That is, a change rate of the grip force relative to the motion of the finger part 20 is small. Such a small change rate of the grip force relative to the motion of the finger part 20 makes the grip force applied from the finger part 20 to the grip target object 8 easily controllable. As a result, excessive grip force which may damage the grip target object 8 is less likely to be applied.

The grip force FX causes friction force between the grip target object 8 and the elastic member. When the grip target object 8 does not slide with respect to the elastic member (when the grip target object 8 is stationary with respect to the elastic member), static friction force is generated between the grip target object 8 and the elastic member in such a manner as to balance with inertial force FZ (for example, inertial force attributed to gravity or acceleration of the robot 2) applied to the grip target object 8. As a result, the inertial force FZ acts in a direction intersecting the direction (gripping direction) in which the grip force FX acts at the contact point 8P between the grip target object 8 and the elastic member.

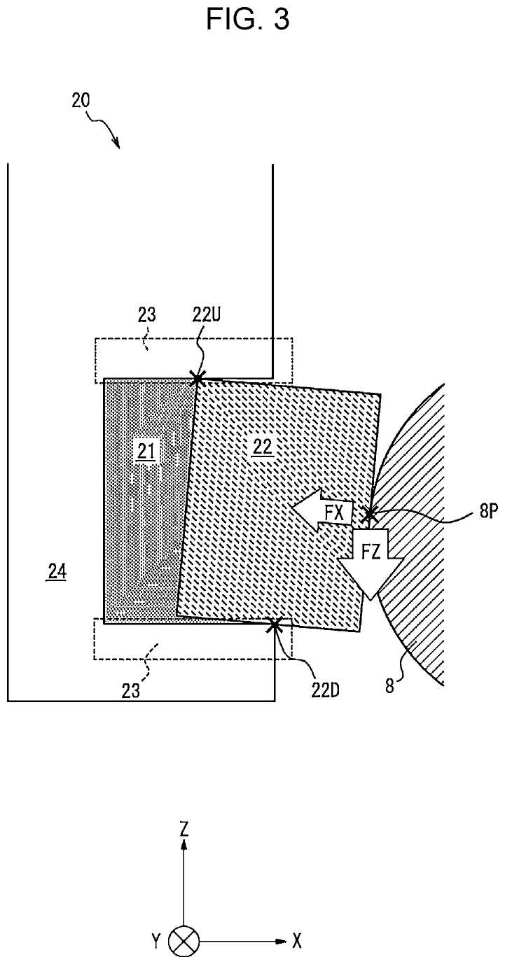

When the inertial force FZ in a Z-axis negative direction acts on the contact point 8P of the elastic member, as illustrated in FIG. 3, the contact point 8P of the elastic member moves in the Z-axis negative direction. The contact point 8P is in contact with the grip target object 8. The inertial force FZ acts as shear force on the second elastic member 22. The support 23 positioned in the Z-axis negative direction supports the second elastic member 22 at a support point 22D, and the support 23 positioned in a Z-axis positive direction supports the second elastic member 22 at a support point 22U. That is, the support 23 supports at least a portion of the elastic member so as to regulate motion of the grip target object 8 in the second direction. In this case, the shear force acts in such a manner as to bend the second elastic member 22 in the Z-axis negative direction with the support point 22D functioning as a fulcrum. Assume that flexural rigidity of the second elastic member 22 in the Z-axis negative direction at the support point 22D is high enough to make the bending via the shear force ignorable. The flexural rigidity of the second elastic member 22 in the Z-axis negative direction at the support point 22D is calculated as a product of a Young's modulus of the second elastic member in the Z-axis direction, and a second moment of area of the second elastic member 22 in the Z-axis direction in a section including the support point 22D in the Z-axis direction.

In a case in which the second elastic member 22 easily bends in the Z-axis direction at the support point 22D, a surface of the second elastic member 22 inclines in the Z-axis direction. The surface is in contact with the grip target object 8. Inclination of the contact surface between the second elastic member 22 and the grip target object 8 in the Z-axis direction reduces the static friction force. Smaller static friction force makes the grip target object 8 prone to sliding. Therefore, when the second elastic member 22 is less likely to bend in the Z-axis direction at the support point 22D, the grip target object 8 is less likely to slide. Further, when an inclination angle of the second elastic member 22 with respect to the gripping direction is less than a given angle, the static friction force is less likely to decrease. As a result, the grip target object 8 is less likely to slide. The given angle may be determined based on a characteristic of the grip target object 8. The characteristic of the grip target object 8 may include, for example, a mass of the grip target object 8, a static friction coefficient or a kinetic friction coefficient between the grip target object 8 and the second elastic member 22, or grip force to an extent which does not cause damage to the grip target object 8. The second elastic member 22 may have a reduced inclination angle with respect to the gripping direction by way of setting a gap between the recess of the finger body 24, the recess functioning as the support 23, and the second elastic member 22 in such a manner as to regulate rotation of the second elastic member 22 with an edge of the support 23 (the recess of the finger body 24) functioning as a rotational axis.

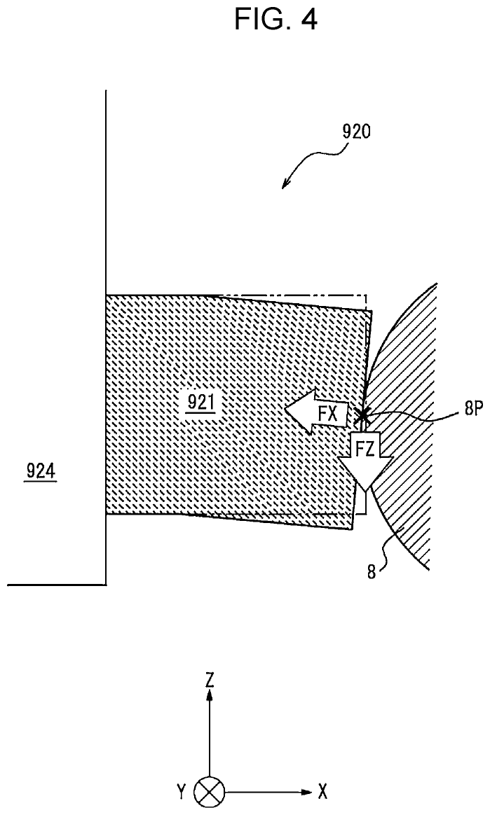

A finger part 920 according to a comparative example includes an elastic member 921 and a finger body 924. When a Young's modulus of the elastic member 921 is low, although excessive grip force is less likely to be applied to the grip target object 8, the elastic member 921 easily bends in the Z-axis direction. The elastic member 921 illustrated in FIG. 4 is bent in the Z-axis direction in comparison with an original shape illustrated by a two-dot chain line (a shape when the grip target object 8 is not gripped). Bending of the elastic member 921 in the Z-axis direction makes the grip target object 8 slide easily.

Conversely, when the Young's modulus of the elastic member 921 is high, although the grip target object 8 is less likely to slide because of the elastic member 921 being less likely to bend in the Z-axis direction, excessive grip force is easily applied to the grip target object 8. Application of excessive grip force to the grip target object 8 may cause damage to the grip target object 8.

In comparison with the comparative example, in the finger part 20 according to the present disclosure, the elastic member has a low Young's modulus in the gripping direction as a whole. Moreover, the flexural rigidity in the direction intersecting the gripping direction is high. Therefore, excessive grip force is less likely to be applied to the grip target object 8. Further, the grip target object 8 is less likely to slide. As a result, gripping stability improves.

### <Regulation Implementation by Regulation Finger 40>

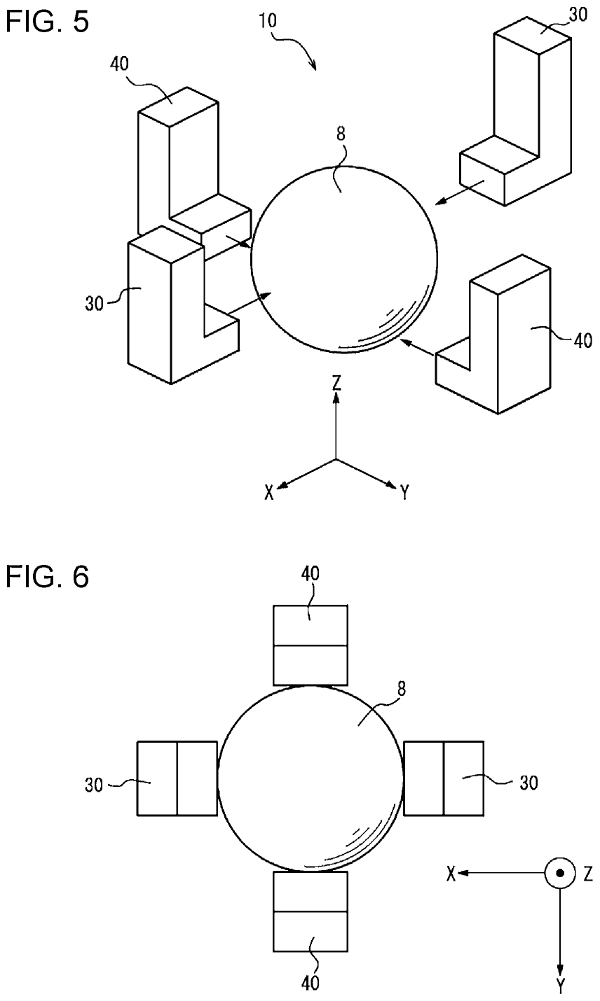

The robot hand 10 may include, as illustrated in FIGS. 5 and 6, a grip finger 30 and a regulation finger 40. The grip finger 30 grips the grip target object 8 in the X-axis direction (first direction). The regulation finger 40 regulates motion, in the Z-axis direction (second direction), of the elastic member of the grip finger 30 in contact with the grip target object 8. In other words, the regulation finger 40 supplementally grips the grip target object 8 when the grip finger 30 grips the grip target object 8, and the regulation finger 40 reduces force which acts on the elastic member of the grip finger 30 in the second direction. Accordingly, the regulation finger 40 indirectly regulates motion of the elastic member of the grip finger 30 in the Z-axis direction (second direction). A Young's modulus and flexural rigidity of a part of the regulation finger 40, the part being in contact with the grip target object 8, are higher than a Young's modulus and flexural rigidity of a part of the grip finger 30, the part being in contact with the grip target object 8. Thereby, the grip finger 30 controls the grip force, and the regulation finger 40 regulates the motion of the grip target object 8 in the second direction. As a result, gripping stability improves.

In other words, a plurality of elastic members may include the first elastic member 21 provided to at least one finger body of the plurality of finger bodies 24, and the second elastic member 22 provided to at least another one finger body of the plurality of finger bodies 24 and having a Young's modulus higher than that of the first elastic member 21. The at least one finger body 24 provided with the first elastic member 21 corresponds to the grip finger 30. The at least another one finger body 24 provided with the second elastic member 22 corresponds to the regulation finger 40.

### BRIEF SUMMARY

As described above, in the present disclosure, the robot hand 10 includes the plurality of finger parts 20 which grips the grip target object 8. The plurality of finger parts 20 includes the plurality of finger bodies 24 and the plurality of elastic members provided to the plurality of finger bodies 24. In this example, for example, the plurality of elastic members includes a portion having a Young's modulus in the first direction lower than a Young's modulus in the second direction. The first direction is the direction in which grip force acts on the grip target object 8, and the second direction intersects the first direction. The robot hand 10 regulates motion of the elastic member in the second direction when the robot hand 10 grips the grip target object 8. Thereby, excessive grip force is less likely to act on the grip target object 8, and the grip target object 8 is less likely to slide. As a result, gripping stability by the robot hand 10 improves.

The elastic member illustrated in FIG. 2 is also referred to as a multilayer elastic member when the elastic member includes a layered structure of the first elastic member 21 and the second elastic member 22. The support 23 supports a portion of the multilayer elastic member. The multilayer elastic member includes a first region and a second region in a portion of the multilayer elastic member, the portion being supported by the support 23. Flexural rigidity in the second direction in the second region is larger than flexural rigidity in the second direction in the first region. The second region is positioned on a closer side to the grip target object 8 further than the first region. For example, the first region and the second region correspond to the first elastic member 21 and the second elastic member 22, respectively. The first region and the second region may correspond to two regions included in the second elastic member 22. The first region and the second region may correspond to two regions divided at any position in the elastic member.

The multilayer elastic member may include, in a section in the second direction at least in the second region, a long-side component in the second direction. The second elastic member 22 included in the multilayer elastic member may have a layer-like shape. A gap between the recess of the finger body 24, the recess functioning as the support 23, and the second elastic member 22 may be set in such a manner as to regulate rotation of the second elastic member 22 with an edge of the support 23 (the recess of the finger body 24) functioning as a rotational axis.

The elastic member may not be a combination of the first elastic member 21 and the second elastic member 22, but may be a single member. The elastic member formed as the single member may have a Young's modulus lower in the first direction than in the second direction.

The first elastic member 21 and the second elastic member 22 may not be joined to one another.

### Other Embodiments

Below, other embodiments are described.

### <Other Configuration Examples of Elastic Member>

The elastic member illustrated in FIG. 2 includes the configuration in which the first elastic member 21 and the second elastic member 22 are layered on one another. Below other configuration examples are described.

### <<Configuration Including First Elastic Member 21 and Second Elastic Member 22 in Section Including Second Direction>>

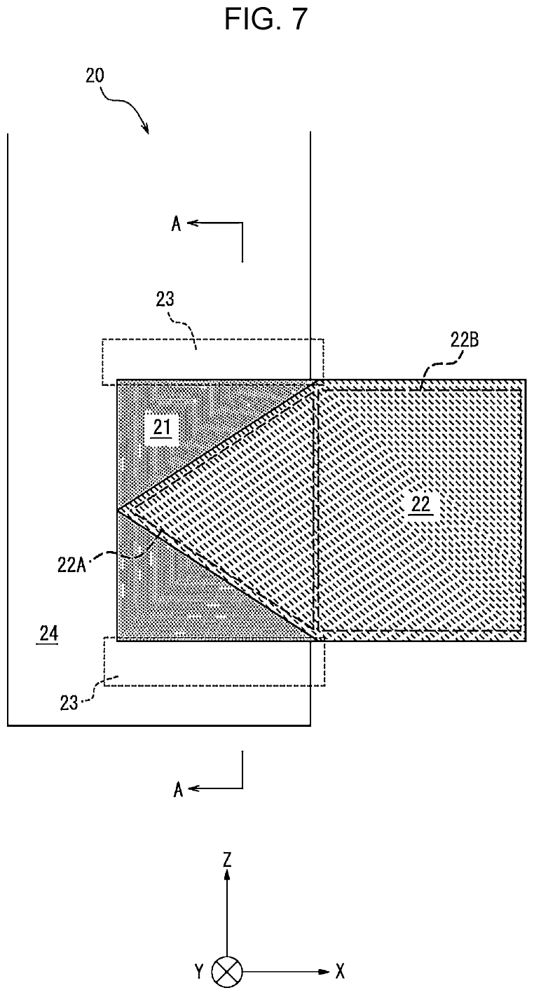

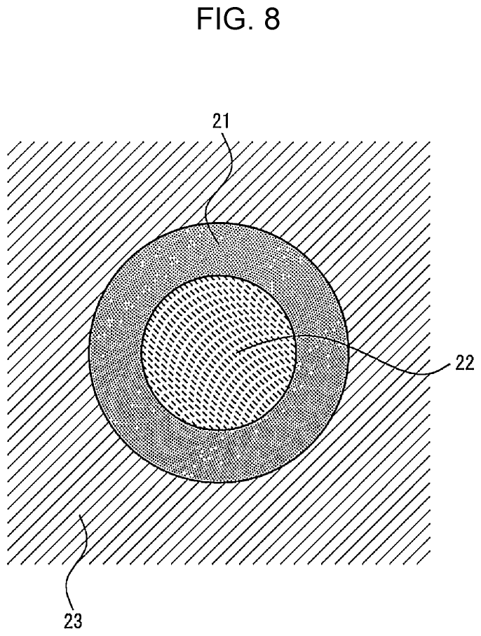

As illustrated in FIGS. 7 and 8, the second elastic member 22 may include a body part 22B and a protrusion 22A. The protrusion 22A is provided on a side of the body part 22B closer to the corresponding finger body of the plurality of finger bodies 24, and has a width smaller than that of the body part 22B. The protrusion 22A of the second elastic member 22 is surrounded by the first elastic member 21 about an axis in the first direction. In other words, a given section intersecting or orthogonal to the gripping direction may contain both the first elastic member 21 and the second elastic member 22.

An apparent Young's modulus in the first direction in any section of the elastic member is determined based on an area ratio in the section, and a Young's modulus of each of the first elastic member 21 and the second elastic member 22 in the first direction. The section intersects the first direction. The area ratio is a ratio of an area of the first elastic member 21 and an area of the second elastic member 22 in the section. A larger area ratio of the first elastic member 21 leads to a lower apparent Young's modulus. On the other hand, flexural rigidity of the elastic member in the second direction at any position is determined based on a second moment of area of each of the first elastic member 21 and the second elastic member 22 in a section including the bend direction. Since the section includes the second elastic member 22, the flexural rigidity in the second direction may improve.

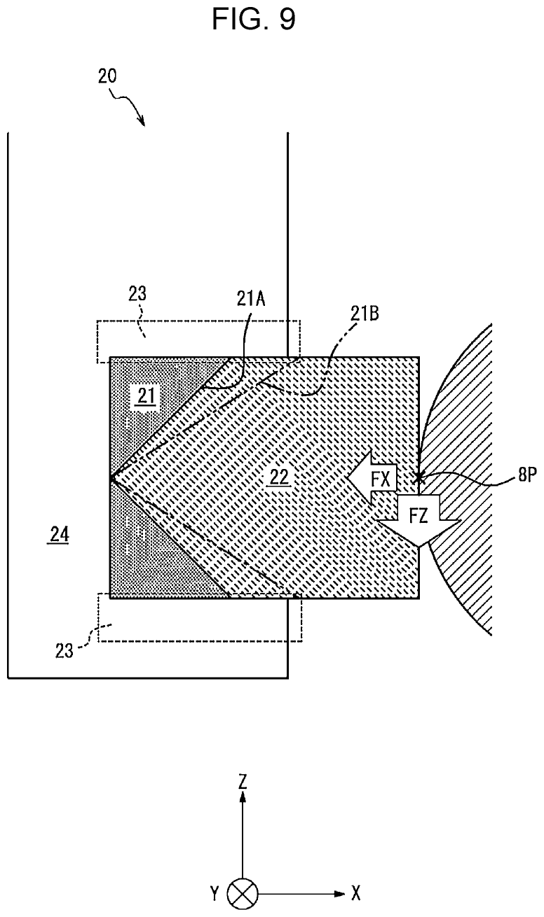

As illustrated in FIG. 9, the grip force FX acts from the grip target object 8 onto the second elastic member 22. The grip force FX causes friction force between the grip target object 8 and the elastic member. When the grip target object 8 does not slide with respect to the elastic member (when the grip target object 8 is stationary with respect to the elastic member), static friction force is generated between the grip target object 8 and the elastic member in such a manner as to balance with inertial force FZ (for example, inertial force attributed to gravity or acceleration of the robot 2) applied to the grip target object 8. As a result, the inertial force FZ acts in a direction intersecting the direction (gripping direction) in which the grip force FX acts.

A solid line 21A indicates an inner-side surface (a surface facing to the grip target object 8) of the first elastic member 21 while the grip force FX acts on the first elastic member 21. On the other hand, a two-dot chain line 21B indicates the inner-side surface of the first elastic member 21 while the grip force FX does not act on the first elastic member 21. A smaller sectional area of the protrusion 22A of the second elastic member 22 reduces the apparent Young's modulus in the first direction. As a result, the protrusion 22A of the second elastic member 22 may deform together with the first elastic member 21 in the first direction.

### <<Configuration of Positioning First Elastic Member 21 on Inner Side of Second Elastic Member 22>>

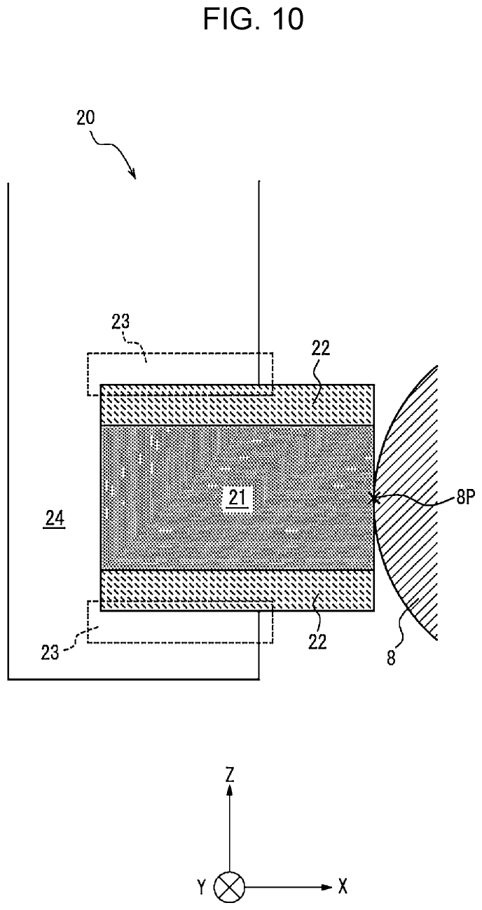

As illustrated in FIG. 10, the elastic member of the finger part 20 may be a combination of the first elastic member 21 extending in the first direction (X-axis direction) in a bar-like manner, and the second elastic member 22 surrounding an outer side of the first elastic member 21 in a tubular manner. That is, the first elastic member 21 and the second elastic member 21 may not be layered on one another in the first direction. The member in which the first elastic member 21 and the second elastic member 21 are combined not to be layered on one another in the first direction is also referred to as a composite elastic member. The composite elastic member may include the first elastic member 21 positioned on the inner side of the second elastic member 22. In other words, the plurality of elastic members may be a composite elastic member including the first elastic member 21 and the second elastic member 22. The first elastic member 21 has a pillar-like shape extending in the first direction. The second elastic member 22 has a pillar-like shape extending in the first direction. The second elastic member 22 has a Young's modulus higher than that of the first elastic member 21. The second elastic member 22 is adjacent to the first elastic member 21. The second elastic member 22 may have a tubular shape. The first elastic member 21 may be positioned inside the second elastic member 22.

The second elastic member 22 may surround the entire circumference of the first elastic member 21 when seen in a section intersecting the first direction (a section including the second direction). The second elastic member 22 may be positioned discretely at the circumference of the first elastic member 21 when seen in the section intersecting the first direction. The second elastic member 22 may be positioned in such a manner as to regulate motion of the first elastic member 21 at least in one direction (for example, the Z-axis negative direction in which gravity acts). The second elastic member 22 may be provided to each of positions at the circumference of the first elastic member 21 when seen in the section intersecting the first direction. The positions are obtained by equally dividing the circumference of the first elastic member 21 into three (positions at intervals of 120 degrees), for example. The second elastic member 22 may be provided to each of positions at the circumference of the first elastic member 21 when seen in the section intersecting the first direction. The positions are obtained by equally dividing the circumference of the first elastic member 21 into four or more (positions at intervals of 90 degrees or less), for example. The position of the second elastic member 22 in the section intersecting the first direction may not be a position obtained by equally dividing the circumference of the first elastic member 21. The second elastic member 22 may be provided to any position at the circumference of the first elastic member 21 when seen in the section intersecting the first direction. The second elastic member 22 may have a plate-like shape, a bar-like shape, or the like extending in the first direction. The second elastic member 22 may have various shapes without being limited to these examples.

The first elastic member 21 first contacts the grip target object 8 when the finger part 20 grips the grip target object 8, and thereby the contact point 8P between the elastic member and the grip target object 8 is positioned at the first elastic member 21. The second elastic member 22 does not contact the grip target object 8. In this case, an apparent Young's modulus of the elastic member in the first direction when the grip target object 8 is gripped is determined based on a Young's modulus of the first elastic member 21. On the other hand, flexural rigidity of the elastic member in the second direction at any position is determined based on a second moment of area of each of the first elastic member 21 and the second elastic member 22 in a section including the bend direction. Since the second elastic member 22 is provided around the first elastic member 21, the flexural rigidity in the second direction may improve.

On a contact side of the first elastic member 21 with the grip target object 8, the first elastic member 21 may protrude further than the second elastic member 22. Thereby, when the finger part 20 grips the grip target object 8, the grip target object 8 first contacts the first elastic member 21 easily. As a result, excessive grip force is less likely to be applied to the grip target object 8.

### <<Configuration of Positioning First Elastic Member 21 on Outer Side of Second Elastic Member 22>>

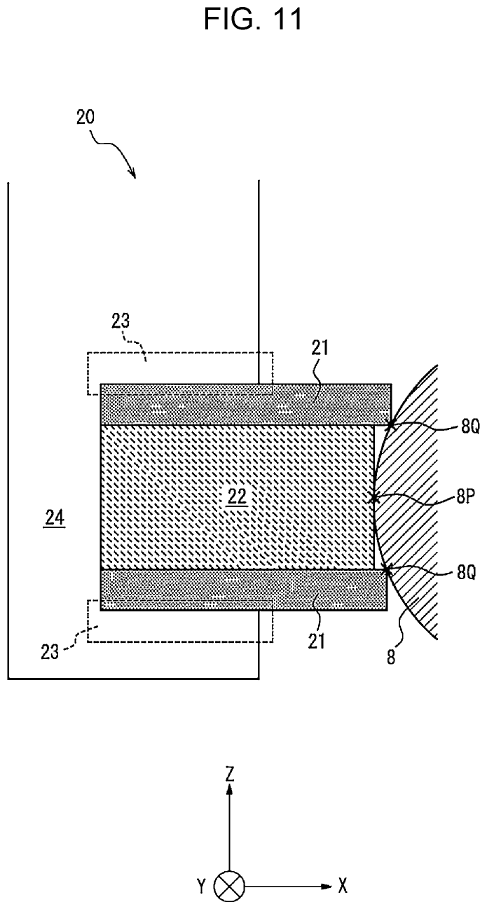

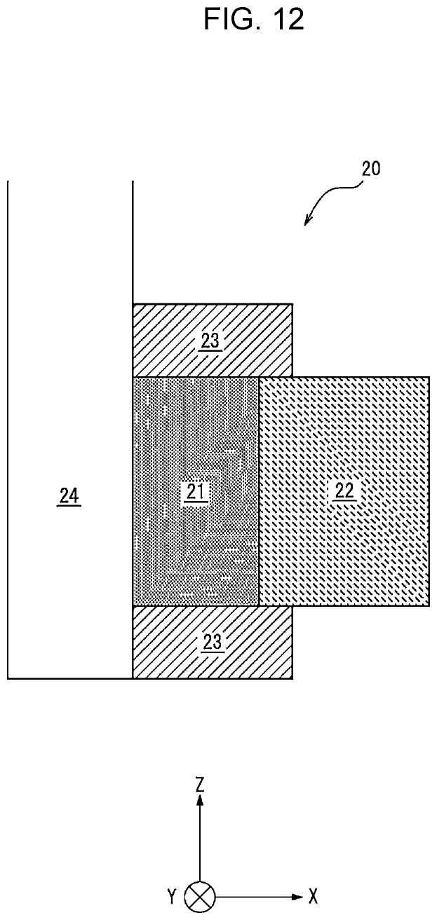

As illustrated in FIG. 11, the elastic member of the finger part 20 may be a combination of the second elastic member 22 extending in the first direction (X-axis direction) in a bar-like manner, and the first elastic member 21 surrounding an outer side of the second elastic member 22 in a tubular manner. When compared with the configuration illustrated in FIG. 10, the positions of the first elastic member 21 and the second elastic member 22 are interchanged between the inner side and the outer side. That is, the composite elastic member may include a configuration in which the first elastic member 21 is positioned on the outer side of the second elastic member 22. In other words, the first elastic member 21 may have a tubular shape. The second elastic member 22 may be positioned inside the first elastic member 21.

On a contact side of the first elastic member 21 with the grip target object 8, the first elastic member 21 may protrude further than the second elastic member 22. In other words, an end portion of the first elastic member 21 may protrude further than an end portion of the second elastic member 22 to the contact side with the grip target object 8. Thereby, when the finger part 20 grips the grip target object 8, the first elastic member 21 first contacts the grip target object 8 at a contact point 8Q. The first elastic member 21 compresses in the first direction as the grip force increases. Compression of the first elastic member 21 allows the grip target object 8 to also contact the second elastic member 22 at the contact point 8P. In this case, an apparent Young's modulus of the elastic member in the first direction when the grip target object 8 is gripped is determined based on a Young's modulus of the first elastic member 21 which first contacts the grip target object 8 at the initial phase of the gripping. As a result, excessive grip force is less likely to be applied to the grip target object 8 at the initial phase of the gripping. After the grip target object 8 contacts the second elastic member 22 as the gripping operation proceeds, flexural rigidity of the elastic member in the second direction at any position is determined based on a second moment of area of each of the first elastic member 21 and the second elastic member 22 in a section including the bend direction. Since the second elastic member 22 in a pillar-like shape is provided inside the elastic member, the flexural rigidity in the second direction may improve.

As described above, combination of the first elastic member 21 and the second elastic member 22 may achieve both reduction in the Young's modulus in the first direction and increase in the flexural rigidity in the direction intersecting the first direction.

### <Other Configuration Examples of Support 23>

As illustrated in FIG. 12, the finger part 20 may include the support 23 formed as a separate body from the finger body 24. The support 23 accommodates the elastic member therein, and at least a portion of the support 23 at the inner side supports the elastic member in such a manner as to regulate motion of the elastic member in the second direction. The support 23 may have a tubular shape such as a cylindrical shape. In other words, the support 23 may surround the entire circumference of the elastic member when seen in a section including the second direction. The support 23 may be positioned discretely at the circumference of the elastic member when seen in the section including the second direction. The support 23 may be positioned in such a manner as to regulate motion of the elastic member at least in one direction (for example, the Z-axis negative direction in which gravity acts). The support 23 may be provided to each of positions at the circumference of the elastic member when seen in the section including the second direction. The positions are obtained by equally dividing the circumference of the elastic member into three (positions at intervals of 120 degrees), for example. The support 23 may be provided to each of positions at the circumference of the elastic member when seen in the section including the second direction. The positions are obtained by equally dividing the circumference of the elastic member into four or more (positions at intervals of 90 degrees or less), for example. The position of the support 23 in the section including the second direction may not be a position obtained by equally dividing the circumference of the elastic member. The support 23 may be provided to any position at the circumference of the elastic member when seen in the section including the second direction. The support 23 may have a plate-like shape, a bar-like shape, or the like extending in the first direction. The support 23 may have various shapes without being limited to these examples.

### <Configuration Example Including Sensor 25>

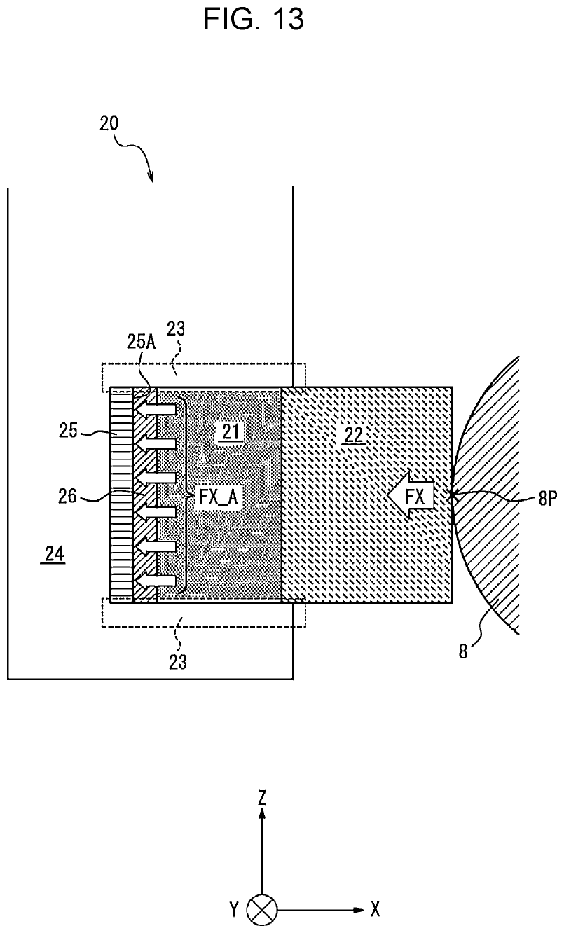

As illustrated in FIG. 13, the finger part 20 may include a sensor 25 which detects the grip force FX via the elastic member. The sensor 25 may be a pressure sensor. In other words, the plurality of finger parts 20 may further include a pressure sensor provided to the plurality of finger bodies 24. The plurality of elastic members may be provided on the pressure sensor.

The sensor 25 includes a sensor surface 25A which detects grip force, thus detecting force which acts on the whole sensor surface 25A. The sensor 25 may be a piezoelectric sensor, a strain gauge, or the like. The sensor 25 detects the grip force FX, which makes estimation of a condition of the grip target object 8 easier. The condition of the grip target object 8 includes whether the grip target object 8 is slipping in the Z-axis direction. The finger part 20 may further include a cover 26 for spreading the grip force FX across the whole sensor surface 25A. A Young's modulus of the cover 26 is higher than a Young's modulus of the first elastic member 21. The force spread via the cover 26 to act on the sensor 25 is illustrated as a load FX_A. In other words, the pressure sensor may include the sensor surface 25A which detects grip force, and the cover 26 which covers at least a portion of the sensor surface 25A. A Young's modulus of the cover 26 in the first direction may be higher than a Young's modulus of the elastic member in the first direction.

Even when the grip force FX which acts on the sensor 25 via the first elastic member 21 includes large variations in the first elastic member 21, the grip force FX which acts on the sensor 25 may spread across the whole sensor surface 25A since the cover 26 which covers the sensor surface 25A has a high Young's modulus. By the force which acts on the respective portions of the sensor surface 25A being more uniform, the sensor 25 may have improved detection precision.

The robot hand 10 may include a force sensor which detects force or torque which acts on the finger part 20, or on the elastic member or the finger body 24. The robot hand 10 may include a current sensor which detects a current flowing in a motor. The motor drives an arm 2A or the robot hand 10.

<Opposed Finger 50 without Elastic Member>

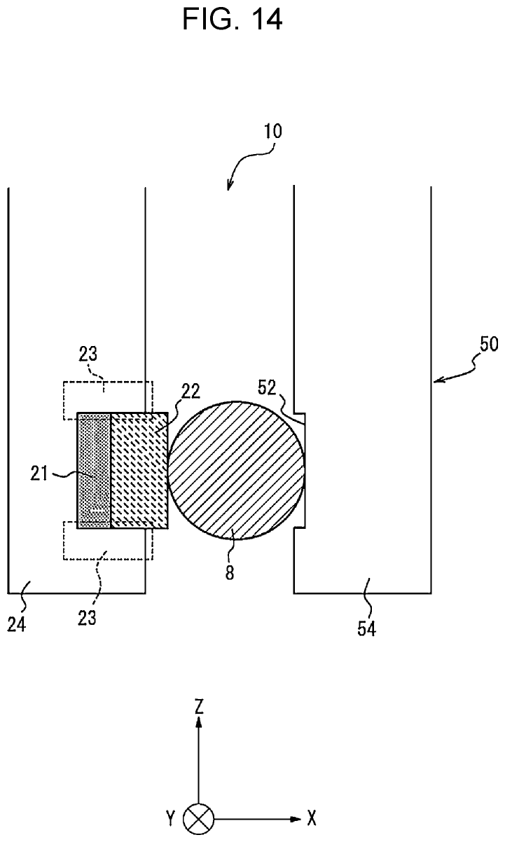

As illustrated in FIG. 14, the robot hand 10 may include the finger part 20 including an elastic member, and an opposed finger 50 not including an elastic member. The opposed finger 50 includes a contact 52 which contacts the grip target object 8, and a finger body 54. The contact 52 may be a recess provided to the finger body 54 as illustrated in FIG. 14. The contact 52 may be a protrusion protruding from the finger body 54. The contact 52 may be flush with finger body 54. The opposed finger 50 or the contact 52 may have an elastic coefficient higher than an elastic coefficient of the elastic member of the finger part 20. Grip force to be applied to the grip target object 8 is easily controllable by the elastic member of the finger part 20, regardless of the elastic coefficient of the opposed finger 50 or the contact 52. The opposed finger 50 may include a more simplified configuration than the finger part 20. Replacement of one finger part 20 with the opposed finger 50 provides a simplified robot hand 10 as a whole. Further, manufacturing costs of the robot hand 10 may decrease.

### <Configuration Example of Robot Control System 1>

As illustrated in FIG. 15, a robot control system 1 according to one embodiment of the present disclosure includes the robot 2 including the robot hand 10 and the arm 2A, and a controller 80 which controls the robot 2. The robot control system 1 may further include an information acquirer 4. The controller 80 may control the robot 2 to grip the grip target object 8 at a work start pedestal 6, and to transfer the grip target object 8 from the work start pedestal 6 to a work target pedestal 7. The robot 2 operates within an operation range 5.

### <<Robot 2>>

The arm 2A of the robot 2 may be a six-axis or seven-axis vertical articulated robot, for example. Alternatively, the arm 2A may be a three-axis or four-axis horizontal articulated robot or a SCARA robot. Alternatively, the arm 2A may be a two-axis or three-axis Cartesian coordinate robot. Alternatively, the arm 2A may be a parallel link robot, or the like. The number of axes included in the arm 2A is not limited to the numbers described as examples. In other words, the robot 2 includes the arm 2A articulated with a plurality of joints and moves by driving of the joints.

### <<Controller 80>>

The controller 80 causes the arm 2A of the robot 2 to move, and thereby can control the position of the robot hand 10. The robot hand 10 may include an axis which serves as a reference for a direction in which the robot hand 10 performs operation on the grip target object 8. In the case in which the robot hand 10 includes an axis, the controller 80 can control a direction of the axis of the robot hand 10 by moving the arm 2A. The controller 80 controls start and end of operation performed on the grip target object 8 by the robot hand 10. The controller 80 controls motion of the robot hand 10 while controlling a position of the robot hand 10, or a direction of the axis of the robot hand 10. Therefore, the controller 80 can move or process the grip target object 8. In the configuration illustrated in FIG. 1, the controller 80 controls the robot 2 to cause the robot hand 10 to grip the grip target object 8 at the work start pedestal 6 and to move the robot hand 10 to the work target pedestal 7. The controller 80 controls the robot 2 to cause the robot hand 10 to release the grip target object 8 at the work target pedestal 7. Accordingly, the controller 80 can transfer the grip target object 8 by the robot 2 from the work start pedestal 6 to the work target pedestal 7.

The controller 80 may include at least one processor. The processor may execute a program for implementing various functions of the controller 80. The processor may be implemented as a single integrated circuit. The integrated circuit is also referred to as an IC (integrated circuit). The processor may be implemented as a plurality of integrated circuits and discrete circuits communicably connected to one another. The processor may be implemented based on various other known techniques.

The controller 80 may include a storage. The storage may include an electromagnetic record medium, such as a magnetic disk, or may include a memory, such as a semiconductor memory or a magnetic memory. The storage stores various pieces of information. The storage stores a program to be executed by the controller 80, and the like. The storage may be a non-transitory readable medium. The storage may function as a work memory of the controller 80. At least a portion of the storage may be separate from the controller 80.

### <<Information Acquirer 4>>

The information acquirer 4 acquires information on the grip target object 8. The information acquirer 4 may include a camera. The camera as the information acquirer 4 captures an image of the grip target object 8 as the information on the grip target object 8. The information acquirer 4 may include a depth sensor. The depth sensor as the information acquirer 4 acquires depth data of the grip target object 8. The depth data may be converted into point cloud information of the grip target object 8.

### <<Operation Example of Robot Control System 1>>

In the robot control system 1, the controller 80 controls the robot 2 to perform work. In this embodiment, the controller 80 controls the robot 2 so that the robot hand 10 grips the grip target object 8. In the case in which the finger part 20 of the robot hand 10 includes the support 23, the finger part 20 can independently regulate motion of the elastic member in the second direction. In such a case, the controller 80 simply controls the robot 2 to cause the finger part 20 of the robot hand 10 to grip the grip target object 8. In a case in which motion of the elastic member in the second direction can be regulated by the robot hand 10 gripping the grip target object 8 by the grip finger 30 while the regulation finger 40 supplementally supports the grip target object 8, the controller 80 controls the robot 2 so that the grip finger 30 and the regulation finger 40 work together.

Although the embodiments according to the present disclosure have been described based on the drawings and the examples, it is to be noted that various changes or alterations will be possible for those skilled in the art based on the present disclosure. Therefore, such changes or alterations are to be understood as being included within the scope of the present disclosure. For example, the functions and the like included in the various components and the like may be reordered in any logically consistent way. Furthermore, multiple components and the like may be combined into one or divided.

All of the configuration elements described in the present disclosure can be combined with each other in any combination except combinations where these characteristics are exclusive to each other. Furthermore, the respective characteristics described in the present disclosure can be replaced by alternative characteristics functioning for the same object, an equivalent object, or a similar object, unless clearly denied. Consequently, unless clearly denied, each of the disclosed characteristics is only an example of a comprehensive series of the same or equivalent characteristics.

Furthermore, the embodiments according to the present disclosure are not limited to any of specific configurations of the embodiments described above. The present embodiments according to the present disclosure can be extended to all the novel characteristics described in the present disclosure, or combinations thereof.

### REFERENCE SIGNS

1 robot control system (4: information acquirer, 5: operation range, 6: work start pedestal, 7: work target pedestal, 8: grip target object (8P, 8Q: contact point), 80: controller)
2 robot (2A: arm)
10 robot hand
20 finger part (21: first elastic member, 22: second elastic member (22A: protrusion, 22B: body part), 23: support, 24: finger body, 25: sensor, 25A: sensor surface, 26: cover)
30 grip finger
40 regulation finger
50 opposed finger (52: contact, 54: finger body)

1. A robot hand comprising:
a plurality of finger parts configured to grip a grip target object, wherein
the plurality of finger parts comprises a plurality of finger bodies and a plurality of elastic members provided to the plurality of finger bodies, and
the plurality of elastic members comprises a portion having a Young's modulus in a first direction lower than a Young's modulus in a second direction, the first direction being a direction in which grip force acts on the grip target object, and the second direction intersecting the first direction.

2. The robot hand according to claim 1, wherein the plurality of elastic members comprises a multilayer elastic member comprising a first elastic member, and a second elastic member layered on the first elastic member and having a Young's modulus higher than a Young's modulus of the first elastic member,
the plurality of finger parts further comprises a support configured to support a portion of the multilayer elastic member,
the multilayer elastic member comprises a first region and a second region in a portion of the multilayer elastic member, the portion being supported by the support, wherein flexural rigidity in a section in the second direction is larger in the second region than in the first region, and
the second region is positioned on a contact side with the grip target object further than the first region.

3. The robot hand according to claim 2, wherein the multilayer elastic member comprises, in a section in the second direction at least in the second region, a long-side component in the second direction.

4. The robot hand according to claim 2, wherein the second elastic member comprised in the multilayer elastic member has a layer-like shape,
the support is configured as a plurality of recesses provided to the plurality of finger bodies, and
a gap between the recess and the second elastic member is set in such a manner as to regulate rotation of the second elastic member with an edge of the support functioning as a rotational axis.

5. The robot hand according to claim 1, wherein the plurality of elastic members comprises a single elastic member having a Young's modulus in the first direction lower than a Young's modulus in the second direction.

6. The robot hand according to claim 1, wherein the plurality of elastic members is configured as a composite elastic member comprising:
a first elastic member having a pillar-like shape extending in the first direction; and
a second elastic member having a pillar-like shape extending in the first direction, the second elastic member having a Young's modulus higher than a Young's modulus of the first elastic member, and the second elastic member being adjacent to the first elastic member.

7. The robot hand according to claim 6, wherein the second elastic member has a tubular shape, and the first elastic member is positioned inside the second elastic member.

8. The robot hand according to claim 6, wherein the first elastic member has a tubular shape, and the second elastic member is positioned inside the first elastic member.

9. The robot hand according to claim 8, wherein an end portion of the first elastic member protrudes further than an end portion of the second elastic member to a contact side with the grip target object.

10. The robot hand according to claim 1, wherein the plurality of finger parts further comprises a support configured to support a portion of the elastic member,
the support is configured as a plurality of recesses provided to the plurality of finger bodies, and
each elastic member of the plurality of elastic members is provided to a respective recess of the plurality of recesses.

11. The robot hand according to claim 1,
wherein the first elastic member and the second elastic member are not joined to one another.

12. The robot hand according to claim 1, wherein the second elastic member comprises a body part, and a protrusion provided on a side of the body part closer to the corresponding finger body of the plurality of finger bodies and having a width smaller than a width of the body part.

13. The robot hand according to claim 1, wherein the plurality of finger parts further comprises a pressure sensor provided to the plurality of finger bodies, and
the plurality of elastic members is provided on the pressure sensor.

14. The robot hand according to claim 13, wherein the pressure sensor comprises a sensor surface configured to detect the grip force and a cover configured to cover at least a portion of the sensor surface, and
a Young's modulus of the cover in the first direction is higher than a Young's modulus of the elastic member in the first direction.

15. The robot hand according to claim 1, wherein the plurality of elastic members comprises:
a first elastic member provided to at least one finger body of the plurality of finger bodies; and
a second elastic member provided to at least another one finger body of the plurality of finger bodies and having a Young's modulus higher than a Young's modulus of the first elastic member.

16. A robot comprising:
the robot hand according to claim 1; and
an arm to which the robot hand is connected.

17. A robot control system comprising:
the robot according to claim 16; and
a controller configured to control the robot.
